(19) United States
(12) Patent Application Publication
(10) Pub. No.: US 2014/0074627 A1
(43) Pub. Date: Mar. 13, 2014

(54) TECHNIQUES TO CREATE AN ADVERTISING CAMPAIGN

(71) Applicants: Ezra Kucharz, Glen Rock, NJ (US); Elizabeth Ann Mozian, Hoboken, NJ (US); Jana L. Meron, Rye Brook, NY (US)

(72) Inventors: Ezra Kucharz, Glen Rock, NJ (US); Elizabeth Ann Mozian, Hoboken, NJ (US); Jana L. Meron, Rye Brook, NY (US)

(73) Assignee: CBS RADIO INC., New York, NY (US)

(21) Appl. No.: 13/611,063

(22) Filed: Sep. 12, 2012

(51) Int. Cl. G06Q 30/02

(52) U.S. Cl. 705/14.72

(57) ABSTRACT

Techniques to provide a web-based system for local online advertising are described. A processor component executing on a web server and controlling a website may manage a website management component that may manage sessions associated with an account of a user while interacting with the website. An ad campaign profile engine including a campaign profile wizard may guide and assist the user in automatically creating multiple advertising campaigns. The campaign profile wizard may further accept a selection of one of the multiple advertising campaigns. An ad builder engine including an ad creation wizard may guide and assist the user in creating online and offline content for the selected advertising campaign. Other embodiments are described and claimed.

### BACKGROUND

Digital advertising is increasing in popularity with local advertisers often overwhelmed with the multiplicity of options. A local advertiser can pursue offline advertising by utilizing traditional mediums such as local television, radio or outdoor billboards. Local advertisers also can utilize online web advertising. In addition, with digital convergence between traditional forms of advertising and online advertising, there are new forms of advertising becoming more popular as well including electronic billboards that may include interactive elements to them as well as digital streaming of audio and/or video over the Internet. Digital advertising is now appearing in many shapes and forms, with the goal of delivering a targeted and coordinated message to a vast audience by utilizing these various different digital forms of advertising. Businesses that can intelligently create, integrate, manage and execute targeted localized digital and traditional advertising campaigns may reap significant competitive advantages.

### SUMMARY

Various embodiments are generally directed to techniques to create an advertising campaign. Some embodiments are particularly directed to techniques to create an advertising campaign to be distributed both online among Internet websites using static (e.g., banner ads) and dynamic (e.g., streaming audio and streaming video) advertisements and/or traditionally among media outlets such as, for instance, broadcast radio, broadcast television, and outdoor signage. In one embodiment, for example, a system may comprise a processor component executing on a web server and controlling a website. An ad campaign profile engine that includes a campaign profile wizard may receive and process user input and automatically create one or more potential advertising campaigns that may include both online and offline media outlet preferences. The campaign profile wizard may further accept a selection of one of the advertising campaigns to be implemented. An ad builder engine that includes an ad creation wizard may then guide and assist the user in creating advertising content for both online and traditional media outlets for the selected advertising campaign. Other embodiments are described and claimed.

Certain illustrative aspects are described herein in connection with the following description and the annexed drawings. These aspects may be indicative of the various ways in which the principles disclosed herein can be practiced. In addition, these aspects and any equivalents are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a block diagram of an embodiment of a system to create an advertising campaign.

FIG. 2 illustrates an embodiment of a logic flow for the system of FIG. 1.

FIG. 3 illustrates an embodiment of a computer screen image for creating an advertising profile for an advertising campaign.

FIG. 4 illustrates an embodiment of a computer screen image for entering data pertaining to a budget for an advertising campaign.

FIG. 5 illustrates an embodiment of a computer screen image for entering data pertaining to a duration for an advertising campaign.

FIG. 6 illustrates an embodiment of a computer screen image for entering data pertaining to a location for an advertising campaign.

FIG. 7 illustrates an embodiment of a computer screen image for entering data pertaining to an audience for an advertising campaign.

FIG. 8a illustrates an embodiment of a computer screen image for entering data pertaining to a category for an advertising campaign.

FIG. 8b illustrates an embodiment of a computer screen image for entering data pertaining to products or services associated with a business category for an advertising campaign.

FIG. 9a illustrates an embodiment of a computer screen image for entering data pertaining to media preferences for an advertising campaign.

FIG. 9b illustrates an embodiment of a computer screen image for entering data pertaining to genres of media preferences for an advertising campaign.

FIG. 10 illustrates an embodiment of a computer screen image for illustrating multiple advertising campaign options.

FIG. 11 illustrates an embodiment of a computer screen image for illustrating a selected advertising campaign option.

FIG. 12 illustrates an embodiment of a computer screen image for selecting creative options for a selected advertising campaign.

FIG. 13 illustrates an embodiment of a logic flow for the creation of online advertising content.

FIG. 14 illustrates an embodiment of a computer screen image for creating online content for a selected advertising campaign.

FIG. 15 illustrates an embodiment of a computing architecture.

### DETAILED DESCRIPTION

Various embodiments described herein may be implemented as part of a Media Ad System (MAS). The MAS is a web-based tool (e.g., MAS website) that businesses (e.g., users) may interact with to create and execute a custom advertising campaign for their business.

The MAS website may cause a user to provide various advertising campaign profile criteria in response to prompts from a series of drop down type menus via a web browser interface. The profile criteria may include, for instance, a budget for the advertising campaign, a duration for the advertising campaign, a location for the advertising campaign, the target audience demographic for the advertising campaign, a business category for the user's business, products and/or services to be advertised, and one or more media preferences for the advertising campaign.

The media preferences may include both online and offline media outlets. The term “online” as used herein may refer to media outlets that involve a computer network component such as, for instance, the Internet. Thus, online media outlets may include websites capable of presenting the content of the website along with online advertising content such as, for instance, web banner advertisements, streaming audio clips, and streaming video clips. A digital or electronic billboard may also be considered an online media outlet because it may be remotely programmed over a network. The term “offline” as used herein is intended to cover media outlets that are not considered online. For example, offline media outlets may include traditional broadcast mediums such as broadcast radio stations and broadcast television stations that are capable of presenting advertising content such as audio and video spots (e.g., commercials) in between and within broadcast programming. Offline media outlets may also include outdoor signage properties such as traditional billboards, stadium and arena signage, and smaller outdoor signage options in and around bus-stops, on shopping carts, within bathroom stalls, and the like. The embodiments are not limited to these examples.

The MAS website may process the received advertising campaign profile criteria data to automatically create one or more advertising campaign packages. The advertising campaign packages may include either 100% online media preferences or some combination of online and offline media preferences. The user may then select an advertising campaign package from among the automatically generated advertising campaign packages generated by the MAS website.

Once an advertising campaign has been selected, the next step may be to create advertising content. A user may choose to use a MAS ad creation wizard to create various advertising content or they can upload their own creative expression of advertising content into a MAS web server via the MAS website. The user may also be provided the opportunity to purchase a creative consultation in which a professional can assist in creating the advertising content for the selected advertising campaign. Once the advertising content has been created, the MAS website may execute the selected advertising campaign by forwarding the advertising content to the selected media preferences on which the advertising content will appear.

Such an approach may include causing the posting of a banner advertisement on a website, causing the insertion of audio copy into a broadcast radio program, causing the insertion of a video advertisement (e.g., television commercial) into a broadcast television program, causing the insertion of audio copy into a web-enabled streaming audio application, and/or causing the insertion of a video advertisement into a web-enabled streaming video application.

The MAS, as described herein, may provide a number of advantages to a business. For instance, a user may initiate, manage and control entire advertising campaigns comprised of online and offline media preferences from a single interface (e.g., MAS website). In addition, the profile criteria gathered and used by the MAS ensures that the scope of an advertising campaign is localized to maximize its effectiveness.

With general reference to notations and nomenclature used herein, the detailed descriptions which follow may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

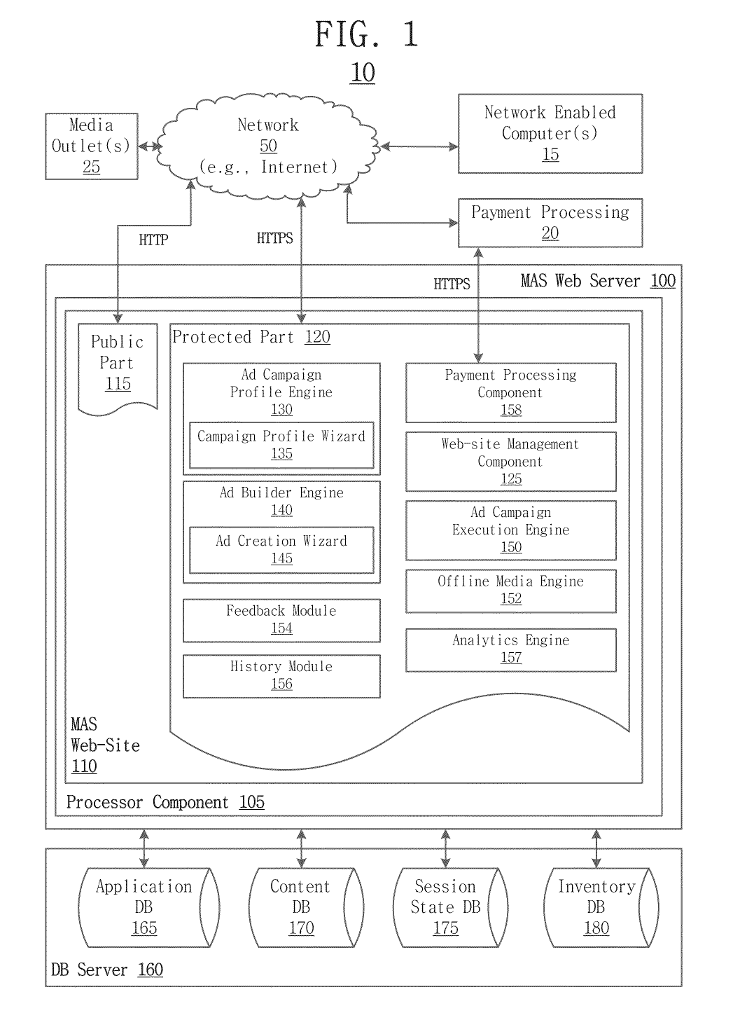

FIG. 1 illustrates a block diagram of an embodiment of a system 10 to create an advertising campaign. In one embodiment, the system 10 may comprise a computer-implemented system having one or more components. Although the system 10 shown in FIG. 1 has a limited number of elements in a certain topology, it may be appreciated that the system 10 may include more or less elements in alternate topologies as desired for a given implementation.

The system 10 may include a network device, such as a MAS web-server 100. The MAS web server 100 may be generally arranged to host and execute one or more additional MAS components. For instance, the MAS web server 100 may host a MAS website 110. The MAS website 110 may be stored on the MAS web server 100 and operable on a processor component 105. The MAS website 110 may be divided into two parts. The MAS website 110 may include a public part 115 and a protected part 120. The public part 115 of MAS website 110 may include general information that does not need to be specially protected via secure access techniques. Typically, the public portion 115 of the MAS website 110 does not allow access to any type of user account information (e.g, user ID/password pairs), financial information (e.g., credit card numbers), or specific application information that is shared between a user and the MAS web server 100. Thus, when a user via a web browser seeks access to the public part 115 of MAS website 110, access may be granted over a connection such as, for instance, the Hypertext Transfer Protocol (HTTP). Other protocols may be used as well, and the embodiments are not limited in this context.

HTTP is an application protocol for distributed communication among networked computers. HTTP is the protocol to exchange or transfer hypertext. HTTP functions as a request-response protocol in the client-server computing model. In this case, a web browser, for example, may be the client and an application running on processor component 105 hosting MAS website 110 may be the MAS web server 100. The client submits an HTTP request message to the MAS web server 100. The MAS web server 100, which provides resources such as Extensible Markup Language (XML) files, Hypertext Markup Language (HTML) files and other content, or performs other functions on behalf of the client, returns a response message to the client. The response contains completion status information about the request and may also contain requested content in its message body.

The protected part 120 of MAS website 110 may include information and applications that are specific and unique to individual users of the MAS website 110. Thus, when one of these users accesses the MAS website 110, it can be done over a secure connection such as, for instance, the Hypertext Transfer Protocol Secure (HTTPS) or other secure communications protocol.

HTTPS is a communications protocol for secure communication over a computer network. HTTPS is widely deployed on the Internet. HTTPS is the result of layering HTTP on top of a secure socket layer (SSL)/transport layer security (TLS) protocol, thus adding the security capabilities of SSL/TLS to standard HTTP communications. HTTPS may provide authentication of the MAS website 110 and associated MAS web server 100 with which a remote computer is communicating over a network. HTTPS provides bidirectional encryption of communications between a client and MAS web server 100, protecting against eavesdropping and tampering with and/or forging the contents of a communication. In the present example, HTTPS provides a reasonable guarantee that a remote computer is communicating with the intended MAS website 110 and ensures the contents of communications between the user and MAS website 110 cannot be read or forged by a third party.

The MAS web server 100 may be communicable over a network 50 such as, for instance, the Internet. In turn, the network 50 may be communicable with multiple network enabled computers 15. The network enabled computers 15 may be operated by users. The connections between the network enabled computers 15 and the MAS web server 100 over network 50 may be achieved using the aforementioned HTTP or HTTPS depending on the part of the MAS website 110 with which a network enabled computer 15 wishes to communicate.

The MAS web server 100 may also communicate with one or more media outlets 25 over network 50 for the purpose of delivering advertising content in digital format from the MAS web server 100 to the media outlet 25. The media outlets 25 may include other websites executed by other web servers, broadcast radio stations, television stations, and electronic signage devices. The other websites may be operative to accept and display banner type advertisements, streamed audio advertisements, and streamed video advertisements. Delivery of digitally formatted advertising content to the media outlets may be accomplished via network 50.

For media outlets 25 that are broadcast television stations, the MAS web server 100 may deliver the digitally formatted advertising content to a web server under control of and associated with the broadcast television station. The broadcast television station web server may be part of a larger computer system implemented by the broadcast television station. This larger computer system may be responsible for delivering the received digitally formatted advertising content from its web server to other components under control of the larger computer system such that the digitally formatted advertising content may be presented by the media outlet 25 (e.g., broadcast radio station) as intended.

For media outlets 25 that are broadcast radio stations, the MAS web server 100 may deliver the digitally formatted advertising content to a web server under control of and associated with the broadcast radio station. The broadcast radio station web server may be part of a larger computer system implemented by the broadcast radio station. This larger computer system may be responsible for delivering the received digitally formatted advertising content from its web server to other components under control of the larger computer system such that the digitally formatted advertising content may be presented by the media outlet 25 (e.g., broadcast television station) as intended.

For media outlets 25 that are electronic signs, the MAS web server 100 may deliver the digitally formatted advertising content to the electronic sign itself if the electronic sign is network enabled or to a web server of a remotely located computer system that controls the electronic sign. The remotely located computer system , if applicable, may then be responsible for delivering the received digitally formatted advertising content from its web server to the electronic sign such that the digitally formatted advertising content may be presented by the media outlet 25 (e.g., the electronic sign) as intended.

The protected part 120 of MAS website 110 may include multiple components. The multiple components may include, for instance, a website management component 125, an ad campaign profile engine 130, an ad builder engine 140, an ad campaign execution engine 150, an offline media engine 152, a feedback module 154, a history module 156, an analytics engine 157, and a payment processing component 158.

The website management component 125 may comprise a software application operative on the processor component 105 that controls the administrative functions of the MAS website 110. The website management component 125 may be generally arranged to manage the interfaces between the MAS website 110 and other external components such as a network 15 (e.g., Internet) and multiple databases. For example, the MAS website 110 may be communicable with a database server 160. The database server 160 may be communicable with the MAS web server 100 over a local network connection and may include an application database 165, a content database 170, a session database 175, and an inventory database 180. Communications with the application database 165, content database 170, session database 175, and inventory database 180 may be performed by, for instance, a structured query language (SQL) interface. The embodiments are not limited to these examples.

The application database 165 may store without limitation information pertaining to user registration such as login data, billing information, user information such as contact data, and user advertising campaign information. The content database 170 may store without limitation ad templates and created ads. The session database 175 may store without limitation the status of a user's account and the state at which they last interacted with the MAS website 110. The inventory database 180 may receive and store updated inventories and schedules of broadcast radio and television spots for multiple broadcast radio and television stations. The inventory database 180 may also receive and store updated inventory data pertaining to the availability of multiple outdoor signage properties. The embodiments are not limited to these examples.

The website management component 125 may be further arranged to manage the MAS website 110 accounts of end users and access by end users to the MAS website 110. There may be two types or levels of MAS website 110 users—users and website administrators. MAS website 110 administrators may control information and services provided to the users on the protected 120 and public 115 parts of the MAS website 110. MAS website 110 administrators may collect information and generate reports pertaining to users activities such as subscriptions, payments, registrations, etc. Users may use the MAS website 110 to subscribe to various services provided by the MAS website 110, and pay for them using credit card payments. Users may be able to access a history of their operations and the current status of their subscriptions. All communications between the MAS website 110 and its users may be performed over HTTPS.

The website management component 125 may be further arranged to manage the user registration process. For example, users may register with the MAS website 110 using an appropriate SSL-protected website form. In one embodiment, Captcha (Completely Automated Public Turing Test To Tell Computers and Humans Apart) may be used to protect against automated registration attempts. Captcha is a type of challenge-response test used in computing as an attempt to ensure that the response is generated by a person. The process usually involves a computer prompting a user to complete a simple test which the computer is able to grade. These tests are designed to be easy for a computer to generate, but difficult for a computer to solve, so that if a correct solution is received, it can be presumed to have been entered by a human. A common type of Captcha (e.g., http://captcha.net/) developed at Carnegie Mellon University requires the user to type letters or digits from a distorted image that appears on the screen. Such tests are commonly used to prevent unwanted internet bots from accessing web sites.

Registration may further entail creating a private user identifier (ID)/password pair using an SSL-protected website form that corresponds with the user. A registered user may login to the MAS website 110 by providing their private user ID/password pair. If a User ID does not exist, a generic error message may be displayed such as, “Wrong login or password”. A user's User ID and password may be stored in the application database 165.

The user's password may be hashed such that the user's hashed password may be compared with one stored in the application database 165. If it is incorrect, the same error message may be displayed. The MAS website 110 may employ techniques that make it impossible to recover a forgotten password. Rather, a new password may be assigned using a standard access recovery and verification routine. The verification routine may entail having the user answer one or more pre-determined personal questions the user chose during the registration process. The embodiments are not limited to these examples.

The website management component 125 may be further arranged to manage the sessions of users when interacting with the MAS website 110. A session typically includes the interactions a user has with the MAS website 110 between logging in with their User ID/password and logging out. The user's input and any data created or changed as a result of the input may be logged and recorded for that session. Session management may also involve requiring the user to re-login if the session has expired (e.g., a certain time limit has passed without user activity). Session management may also be used to store information on the server-side between HTTPS requests.

Session information may be stored in the session database 175 using a session identifier generated as a result of a successful login request from the user. The “storage” of session IDs and the associated session data (user name, account number, etc.) in the session database 175 may be accomplished using a variety of techniques including, but not limited to: local memory, flat files, and databases. In situations where multiple web servers (e.g., MAS web server 100 and database server 160) share knowledge of session state, session information may be shared among the web servers. Methods for sharing session state among the web servers may include multicasting session information to member web servers, sharing session information with a partner web server using distributed shared memory or memory virtualization, sharing session information between web servers using network sockets, storing session information on a shared file system such as a network file system or a global file system, or storing the session information in a database (e.g., session database 175). The embodiments are not limited to these examples.

The session information stored in the session database 175 may serve to provide continuity to a user. For example, a user may be asked to perform many steps to set up an advertising campaign. However, the user may not achieve all the steps in a single session. The MAS website 110 may permit the user to store a previous session and pick up in a future session where they left off in the previous session without having to re-enter any data.

The ad campaign profile engine 130 is another feature of the MAS website 110 and may comprise a software application operative on the processor component 105 generally arranged to guide and assist a user in creating an advertising campaign. The ad campaign profile engine 130 may include an ad campaign profile wizard 135 to perform this function. The ad campaign profile wizard 135 may be a software tool that prompts the user for responses to multiple advertising campaign criteria and generates multiple advertising campaigns from which the user can select. For example, the advertising campaign criteria may include a budget, a duration, a location, a target audience, a business category, and one or more media preferences, among other criteria. These criteria may be analyzed and weighted to determine multiple alternative advertising campaign packages.

The budget criteria may refer to the amount of money the user is willing to spend on the advertising campaign. The duration criteria may refer to the length of time that the advertising campaign may run. The location criteria may refer to the geography that the user wishes to cover with the advertising campaign. The target audience criteria may refer to the demographic of people the user most wishes to reach with the advertising campaign. The business category criteria may refer to the type of business the user is in. The product or service to be advertised may refer to the specific products and services offered by the user. The media preferences criteria may refer to the types of advertising the user is willing to engage in for the advertising campaign. Some examples of media preferences include, but are not limited to, website advertisements, online streaming audio advertisements, online streaming video advertisements, broadcast radio advertisements, broadcast television advertisements, and outdoor signage advertisements.

The ad campaign profile engine 130 may be further arranged to present multiple advertising campaigns to the user. Each advertising campaign may have a total cost associated therewith as defined by the budget criteria. The multiple advertising campaigns may be the result of processing the responses entered by the user to the various criteria.

For example, the three main advertising campaign criteria may be budget, duration, and location. These criteria may control the overall framework of an advertising campaign. The other criteria of audience, business category (including goods and services to be advertised), and media preferences may assist in creating a localized advertisement campaign. In addition, the ad campaign profile engine 130 may access the history module 156 to find other ad campaigns that provided similar responses to the advertising profile criteria. The history module 156 may then look at the implementation of the previous similar campaign as well as any feedback regarding the effectiveness of the previous campaign as a whole and the effectiveness of individual aspects of the previous campaign. For instance, the previous campaign may have used several static and electronic billboards throughout the city of Philadelphia. Feedback from that campaign may indicate that the billboards in South Philadelphia were effective and the billboards in West Philadelphia were ineffective. Moreover, the feedback for the previous campaign may further indicate that the optimal time for the billboards was between 4:00 PM and 7:00 PM especially on days when the professional baseball team had a home game. Thus, a historical assessment of a previous advertising campaign by the history module 156 using data obtained by the feedback module 154 may be used to make recommendations for a present advertising campaign. This information may be stored in the application database 165. The history module 156 may provide, for instance, a historical assessment of data indicative of the success of particular advertising campaigns that have already been executed. Successful advertising campaigns having similar advertising profile criteria to the present advertising profile criteria may be evaluated to determine what types of media preferences were used, the allocation of budget among media preferences, and other characteristics of the advertising campaign that made it successful. In addition, the search for similar campaigns may be extended to other locations of similar demographics. For example, the Boston market may be similar to the Philadelphia market in many ways. Both are large cities situated in the northeast with passionate sports fan bases. Both utilize similar mass transit systems and have a similar overall demographic make-up. Thus, advertising campaigns executed in Boston may be comparable to those executed in Philadelphia and vice-versa.

The analytics data within the history module 156 may then be used to influence the recommendations made by the ad campaign profile engine 130 when creating advertising campaign packages based on the present advertising profile criteria.

Analyzing the data to help determine the best, most cost effective advertising campaign package may involve performing analytics and personalization tasks to determine the best places, times, and media outlets to spend budget. While some of the analytics and personalization tasks have been described herein for exemplary purposes, many more are possible and the disclosure is not limited to the examples presented herein. Other examples of analytics and personalization techniques may be found in the following commonly owned patent applications: U.S. application Ser. No. 12/792,976 filed Jun. 3, 2010 entitled “Method and Apparatus for Marketing Over an On-Line Network”; U.S. application Ser. No. 12/942,823 filed Nov. 9, 2010 entitled “Apparatus And Methods For Providing Targeted Advertising From User Behavior”; U.S. application Ser. No. 13/023,377 filed Feb. 8, 2011 entitled “Targeting Offers to Users of a Web Site”; U.S. application Ser. No. 13/174,695 filed Jun. 30, 2011 entitled “System And Method For Distributing Offers To A Population Of Users Based On Relevancy Determinations”; U.S. application Ser. No. 12/646,530 filed Dec. 23, 2009 entitled “System and Method for Aggregating User Data and Targeting Content”; U.S. application Ser. No. 13/421,480 filed Mar. 15, 2012 entitled “Providing Content Based on Online Topical Trends”; and U.S. application Ser. No. 10/429,929 filed May 5, 2003 entitled “Measuring Customer Interest to Forecast Product Consumption”. The entire contents of the aforementioned patent applications are incorporated herein by reference.

The ad campaign profile engine 130 may also have knowledge of upcoming events that are scheduled for a particular location. This data may also be stored in the application database 165. This local knowledge of upcoming events may also be factored into the recommendations made by the ad campaign profile engine 130.

For example, the city of Philadelphia may be sponsoring a folk music festival down by the waterfront during a specific week. The local professional sports teams may have home games scheduled. The city's arena may be hosting certain other music concerts. The city's museum may be exhibiting a particular show. The theatres downtown may be running plays. Each of these events may appeal to a different demographic. For instance, a rock concert may be scheduled for an upcoming date. Billboards in and around the arena may be set up to advertise to the expected demographic. In another example, the local baseball team may have a homestand during the next several days which may increase the value of outdoor signage in and around the ball park for certain advertising campaigns. Further, by using historical data from the history module 156, further analytics can be performed on how successfully prior ad campaigns were when such events had occurred in the past. By being able to utilize analytics as to the effectiveness of ad campaigns with complementary characteristics, the system is able to not only recommend venues and timing that might be more appropriate for the ad campaign, but also to provide visibility into the potential effectiveness of these different venues.

The audience criteria, for instance, may represent the demographic of consumer that the advertising campaign is trying to reach. The audience may be gender related, age related, income related, or a combination thereof. The media preferences criteria may be considered based on the budget, duration, and location criteria. For instance, if the specified location includes media properties such as radio stations in higher cost areas such as Philadelphia, there must be sufficient budget to accommodate the media preference. If there is sufficient budget, the cost of a radio spot may vary according to the time of day which may also be considered in constructing an ad campaign package. For instance, there may be enough budget for one radio spot during drive time or two radio spots during a time of day that may not have as many listeners such as mid-day. The business category and goods and services to be advertised may also help determine which media preferences may be most suitable to utilize. For instance, outdoor signage such as a billboard (static or electronic) along major roads or highways may be considered a highly desired media preference for an automobile dealership but not as desired for a television manufacturer.

Consider a user that owns a sports car automobile dealership and who wishes to create an advertising campaign. The user may access the MAS website 110 and supply the following information in response to prompts from the campaign profile wizard 135 of the ad campaign profile engine 130. The budget may be set at $50,000. The location may be set to Philadelphia. The duration may be set to four (4) weeks. The audience may be set to men between the ages of 35-54. The business category may be set to automobile sales and the products advertised may be sports cars. Lastly, the media preferences may be set to broadcast radio and video streaming in addition to the default web based advertisements.

The ad campaign profile engine 130 may process this input to create multiple ad campaign packages. One ad campaign package, for example, may be divided by budget among online web ads (50%), online video streaming (15%), and broadcast radio ads (35%). In addition, the ad campaign profile engine 130 may further process the input criteria to recommend that the broadcast radio ads be run in afternoon drive time based on the business category (e.g., automobile dealership of sports cars) to appeal to a demographic of known drivers. Another ad campaign package, for example, may divide the budget among online web ads (40%), online video streaming (20%), broadcast radio ads (30%), and outdoor signage (10%). The outdoor signage may be targeted to specific billboards within two (2) miles of the baseball park during the next homestand to maximize exposure to sports fans. In addition, the ad campaign profile engine 130 may recommend online video streaming on websites (or pages within websites) that are sports oriented based on the business category (e.g., automobile dealership of sports cars) to appeal to a demographic of men.

The user may select one of the advertising campaign packages. Upon selection, the user may be prompted to input payment information for the selected advertising campaign. Payment processing may be handled by the payment processing component 158 in conjunction with a third party payment processing block 20. The third party payment processing block 20 may handle payments associated with, for instance, credit cards, bank debits, and Pay Pal™ accounts. The embodiments are not limited to these examples.

The payment processing component 158 may comprise a software application operative on the processor component 105. The payment processing component 158 may be generally arranged to communicate with a payment processing block 20. The payment processing block 20 may represent a trusted third party responsible for brokering financial transactions between users of network enabled computers 10 and the payment processing component 158 within MAS website 110. All communications involving payment processing block 20 may be done using HTTPS.

Upon payment for a selected advertising campaign, the user may be forwarded to or prompted to access the ad builder engine 140. The ad builder engine 140 may comprise a software application operative on the processor component 105. The ad builder engine 140 may be generally arranged to guide and assist a user in creating advertising content for the selected advertising campaign. The ad builder engine 140 may include an ad creation wizard 145 to perform this function. The ad creation wizard 145 may be a software tool that presents multiple advertisement templates to the user. The user may then be prompted to enter data such as text, graphics, audio, and/or video pertaining to the desired advertisement for the intended media preference within the selected advertising campaign. Thus, the ad creation wizard 145 may assist the user in creating website advertisements, online audio streaming advertisements, online video streaming advertisements, broadcast radio advertisements, broadcast television advertisements, and outdoor signage advertisements.

With regard to website advertisements, the ad creation wizard 145 may obtain website advertising templates from the content database 170. Complete or partially complete website advertisements of the user for a selected campaign may also be stored in the content database 170. Each complete or partially complete online advertisement may be associated with the particular user that created it using a unique identifier. The user may be prompted to enter data pertaining to color and background for the online advertisements. The user may also be prompted to add text, graphics, and/or pictures to the advertisement via the template.

With regard to online audio streaming advertisements, the ad creation wizard 145 may prompt the user to enter data pertaining to audio copy that may be inserted into a digital audio stream. This may entail, for example, drafting the text of an announcement that may be read by an “on-air” personality during a break in live streaming. Alternatively, this may entail pre-recording an audio file or uploading a pre-recorded audio file containing audio copy of an advertisement that may be inserted into a digitally streamed audio program at an appropriate time. Complete or partially complete audio advertisements may also be stored in the content database 170. Each complete or partially complete audio advertisement may be associated with the particular user that created it using a unique identifier.

With regard to online video streaming advertisements, the ad creation wizard 145 may prompt the user to enter data pertaining to video copy that may be inserted into a digital video stream. This may entail, for example, pre-recording a video file or uploading a pre-recorded video file containing the video copy of an advertisement that may be inserted into a digitally streamed video program at an appropriate time. Complete or partially complete video advertisements may also be stored in the content database 170. Each complete or partially complete video advertisement may be associated with the particular user that created it using a unique identifier.

With regard to broadcast radio advertisements, the ad creation wizard 145 may prompt the user to record and/or upload audio copy that may be inserted into a radio broadcast. This may entail, for example, drafting the text of an announcement that may be read by an “on-air” personality during a break in a live broadcast. Alternatively, this may entail pre-recording an audio file or uploading a pre-recorded audio file containing audio copy of an advertisement that may be inserted into a radio broadcast at an appropriate time. Complete or partially complete audio advertisements may also be stored in the content database 170. Each complete or partially complete audio advertisement may be associated with the particular user that created it using a unique identifier.

With regard to broadcast television advertisements, the ad creation wizard 145 may prompt the user to enter data pertaining to video copy that may be inserted into a television broadcast. This may entail, for example, pre-recording a video file or uploading a pre-recorded video file containing the video copy of an advertisement that may be inserted into a television broadcast at an appropriate time. Complete or partially complete video advertisements may also be stored in the content database 170. Each complete or partially complete video advertisement may be associated with the particular user that created it using a unique identifier.

With regard to outdoor signage advertisements, the ad creation wizard 145 may prompt the user to enter data pertaining to the advertising similar to the process described for website advertisements above. This may include, but is not limited to, text, graphics, pictures, background patterns and colors, and other color data.

Once a user has finished creating and reviewing all of the online advertisements associated with a selected advertising campaign, the online advertisements may be uploaded to a portion of the content database 170 associated with its selected campaign and flagged as complete. The selected advertising campaign may now be ready to be executed with the aid of an ad campaign execution engine 150. The ad campaign execution engine 150 may comprise a software application operative on the processor component 105. The ad campaign execution engine 150 may be generally arranged to deliver the advertisement content associated with the selected advertising campaign according to the schedule set out by the duration criteria and to the websites and/or traditional media outlets (e.g., broadcast and/or digital streaming radio or television) specified according to the location criteria.

After the campaign has been executed, the user may be encouraged to provide feedback as to the effectiveness of the selected advertising campaign. The user may log-in to the MAS website 110 and access the feedback module 154. The feedback module 154 may ask the user to answer a series of questions and provide a scaled score of the advertising campaign. For instance, the user may be asked to rank the overall effectiveness of the advertising campaign on a scale of 1 to 10. It should be noted that the 1 to 10 scale is exemplary and not intended to limit the embodiments described herein. The user may also be asked to rank individual aspects of the advertising campaign such as the online component, the broadcast radio component, the video streaming component, etc. This information may be obtained by the user asking “Where did you hear about us?” type questions when interacting with customers or on forms or the like. The overall effectiveness of the ad campaign may be measured by an increase in sales following execution of the campaign.

The data gathered by the feedback module 154 may then be placed in the application database 165 where it may be accessed by the history module 156 to help make recommendations for future advertising campaigns. In addition, the MAS website 110 may process the feedback data for a particular advertising campaign and have the ad campaign profile engine 130 fine tune the recommendations for future advertising campaigns of the same user. These future advertising campaigns may incorporate the aspects of previous advertising campaigns that worked and disregard aspects that did not.

In addition, the MAS may include its own analytics engine 157 that has access to the data obtained by the feedback module 154 and the history module 156. The analytics engine 157 may process the data obtained by the feedback module 154 and the history module 156 to determine trends of advertising campaigns and trends of consumers which may be saved as trend data in the application database 165. The trend data may reflect a shift of effective advertising over time. Using the trend data determined by the analytics engine 157, the recommendations made by the ad campaign profile engine may be skewed to emphasize positive advertising trends and de-emphasize negative advertising trends.

For example, based on click-through rates of web based advertisements, the analytics engine 157 may determine that this type of advertising is trending upward and could be a good way to advertise to consumers. Such a determination may cause the ad campaign profile engine 130 to emphasize online media outlets to a greater proportion. Similarly, the analytics engine 157 may determine that television broadcast media outlets trend lower in effectiveness during the summer months perhaps due to an overall decrease in television viewership during the summer. Thus, an advertising campaign that will be executed during the summer months may de-emphasize broadcast television media outlets. This may be reflected by the ad campaign profile engine 130 increasing the allocated budget for online media outlets and reducing the allocated budget for broadcast television for an advertising campaign. The embodiments are not limited to these examples.

Trend data may be acquired by the analytics engine 157 in a number of different ways. For instance, the analytics engine 157 may receive data pertaining to twitter feeds of various twitter users. The twitter feeds may be indicative of hot topics being discussed, events that will be attended, opinions on different products, etc. In addition, trend data may be obtained directly from an advertising mechanism itself. For instance, an interactive electronic billboard may include a touchscreen. The billboard may solicit consumer feedback by posing questions that may be answered using the touchscreen. These answers may be channeled back to the analytics engine 157 to provide instantaneous feedback pertaining to a product or service, a demographic of user, etc. The embodiments are not limited to these examples.

In advertising campaigns that include an offline component such as broadcast radio, broadcast television or outdoor signage, the user may be directed to interact with the offline media engine 152. The offline media engine 152 may interface with computer systems associated with multiple offline media properties such as individual broadcast radio stations and television stations as well as offline media properties that control and manage outdoor signage. The computer systems of the offline media properties may be communicable with the MAS website 110 through the offline media engine 152. The computer systems of the offline media properties may upload their latest inventory data to the inventory database 180. The inventory data may represent ad spots that are available for purchase for the next 90 days (or some other period of time). The inventory data may further specify the geographic area covered by the offline media property, and a date, time, and cost of the ad spots that are available. This data may be uploaded manually or may be uploaded automatically on a predefined periodic basis. The ad campaign profile engine 130 may utilize the inventory data to help create advertising campaign profiles.

In one example, a representative such as a salesperson of an offline media entity such as a broadcast radio station may be able to access the MAS web site 110 for a variety of purposes. The salesperson (or other personnel) may upload the latest inventory data to the inventory database 180. The ad campaign profile engine 130 may utilize the inventory data to help create advertising campaign profiles. For example, if a user specifies a media preference for broadcast radio in a city like Philadelphia, the ad campaign profile engine 130 may look up the inventory available for broadcast radio stations that serve the Philadelphia area. The other data associated with the inventory such as date, time, cost, demographics for the broadcast radio stations that serve Philadelphia may be factored in when creating multiple ad campaign profiles.

In another example, the broadcast radio station may have an account with the MAS website 110 that may be accessed by designated personnel such as the salesperson. The salesperson may log-in to the MAS website and, via the offline media engine 152, search for ad campaigns of users that specify broadcast radio as a media preference. The search results may be filtered to ensure that only ad campaigns specifying a location served by that broadcast radio station are returned. The salesperson may then attempt to contact the user directly via email or telephone to provide additional information about advertising on the radio.

The above examples apply equally to both broadcast television stations and outdoor signage properties. Thus, a broadcast television station and an outdoor signage property may similarly provide inventory data manually or automatically and maintain an account with the MAS web site 110. The embodiments are not limited to these examples.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

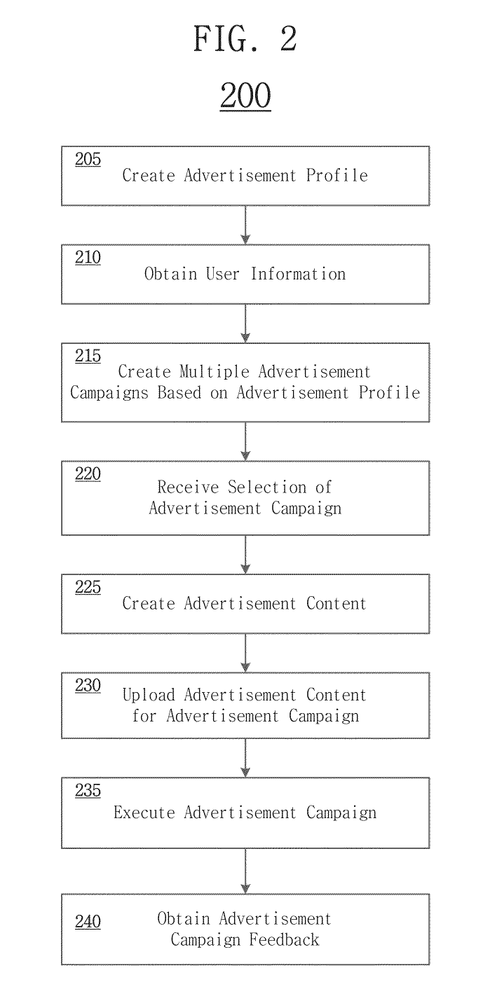

FIG. 2 illustrates one embodiment of a logic flow 200. The logic flow 200 may be representative of some or all of the operations executed by one or more embodiments described herein.

In the illustrated embodiment shown in FIG. 2, the logic flow 200 may create an advertising profile at block 205. For example, a user may browse the MAS website 110 with an intent of creating a localized advertising campaign. To provide choices for a more targeted advertising campaign, the MAS website 110 may query the user to obtain specific information using the campaign profile wizard 135 within the ad campaign profile engine 130 that is running on processor component 105 that controls the MAS website 110. This information may be collected into an advertising profile.

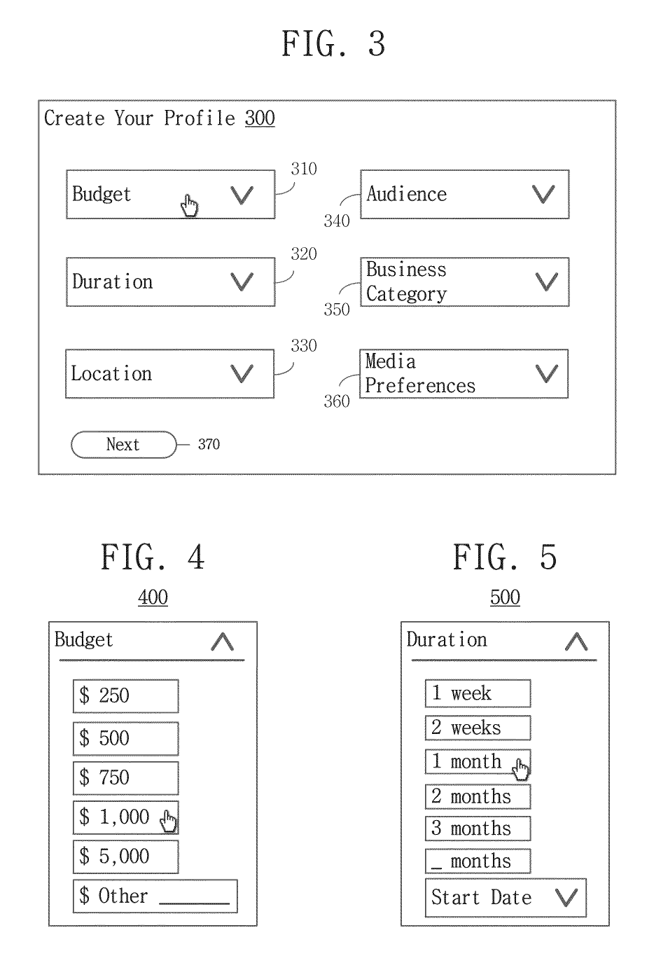

The steps of FIG. 2 may be described with reference to embodiments of a computer screen images shown in FIGS. 3-12. Specifically, FIGS. 3-9 illustrate examples of advertising profile criteria intake pages that may be used by the campaign profile wizard 135 to collect advertising campaign profile information from the user.

FIG. 3 illustrates one example of an embodiment of a computer screen image 300 for creating such an advertising profile for an advertising campaign. The computer screen image 300 may be labeled as a “Create Your Profile” page within MAS website 110. The computer screen image 300 for the “Create Your Profile” page within MAS website 110 may present criteria, in the form of drop down buttons, that include a budget drop down button 310, a duration drop down button 320, a location drop down button 330, an audience drop down button 340, a category drop down button 350, and a media preferences drop down button 360. The user may select each one of these buttons 310-360 to input data pertaining to that button. Upon selection of a button 310-360, the user may be presented with a drop down menu of selections prompting the user to input data. Once the user has completed entering data for each of the criteria 310-360, the user may select a “next” button 370 to advance to the next stage of the process. The embodiments are not limited to this example.

FIG. 4 illustrates one example of an embodiment of a computer screen image 400 for entering data pertaining to a budget for an advertising campaign. The computer screen image 400 may be presented to the user when the user selects button 310 in FIG. 3. Selection of button 310 in FIG. 3 may cause the button to expand to illustrate multiple dollar amounts. The dollar amounts may be representative of an amount of money the user is willing to spend on a potential advertising campaign. There may be button selections for discrete amounts of money as well as an option that may allow the user to input their own budget amount. In this example, the user may have selected the $1,000 budget amount as indicated by the finger icon hovering above the $1,000 button. Upon making a selection or entering data for a budget amount, the logic flow 200 may return to the primary computer screen image 300 for the “Create Your Profile” page within MAS website 110 to allow the user to make another selection. The embodiments are not limited to this example.

FIG. 5 illustrates one example of an embodiment of a computer screen image 500 for entering data pertaining to a duration for an advertising campaign. The computer screen image 500 may be presented to the user when the user selects button 320 in FIG. 3. Selection of button 320 in FIG. 3 may cause the button to expand to illustrate multiple options for a duration or length of time that the advertising campaign may run. There may be button selections for discrete lengths of time ranging from 1 week to 3 months as well as an option that may allow the user to input their own length of time. In this example, the user may have selected a one (1) month duration as indicated by the finger icon hovering above the one (1) month button. Also shown is a drop down button for indicating a preferred start date for the advertising campaign. Selecting this button may illustrate an image of a calendar that may further allow the user to select a specific date to start an advertising campaign. The start date may be chosen, for instance, to coincide with a planned sale. Upon making a selection or entering data for a duration, the logic flow 200 may return to the primary computer screen image 300 for the “Create Your Profile” page within MAS website 110 to allow the user to make another selection. The embodiments are not limited to this example.

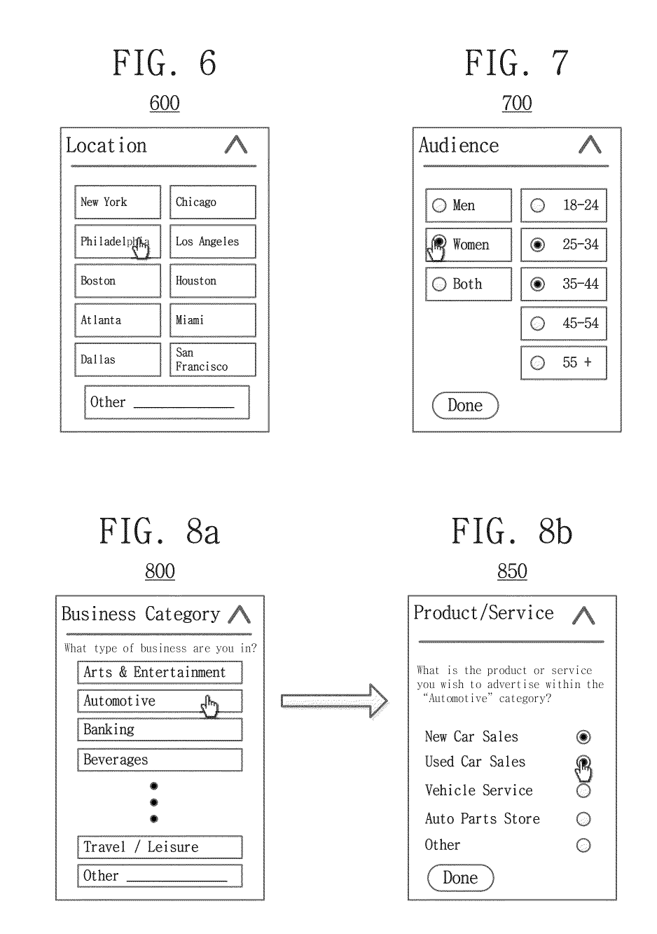

FIG. 6 illustrates one example of an embodiment of a computer screen image 600 for entering data pertaining to a location for an advertising campaign. The computer screen image 600 may be presented to the user when the user selects button 330 in FIG. 3. Selection of button 330 in FIG. 3 may cause the button to expand to illustrate multiple options for a location in which the advertising campaign may be run. There may be several button selections associated with cities or markets. There is also a button marked “Other” that may allow the user to input a city or market not shown. In this example, the user may have selected a location of “Philadelphia” as indicated by the finger icon hovering above the Philadelphia button. For online advertising, the location criteria is indicative of localized websites that serve that particular city or market even though the website may be reached from anywhere in the world at any given moment, the vast majority of visitors to the website will most likely be people that live, work, shop, or plan to visit the location associated with the website. Upon making a selection or entering data for a location, the logic flow 200 may return to the primary computer screen image 300 for the “Create Your Profile” page within MAS website 110 to allow the user to make another selection. The embodiments are not limited to this example.

FIG. 7 illustrates one example of an embodiment of a computer screen image 700 for entering data pertaining to an audience for an advertising campaign. The computer screen image 700 may be presented to the user when the user selects button 340 in FIG. 3. Selection of button 340 in FIG. 3 may cause the button to expand to illustrate multiple demographic data selections. The user may select a preferred gender to target as well as one or more preferred age groups to target. In this example, the user may have selected to target women between the ages of 25-44 as indicated by the finger icon hovering above the “Women” button and the buttons for the age groups 25-34 and 35-44 being filled in. Upon selecting the “Done” button after making a selection or entering data a target audience, the logic flow 200 may return to the primary computer screen image 300 for the “Create Your Profile” page within MAS website 110 to allow the user to make another selection. The embodiments are not limited to this example.

FIG. 8a illustrates one example of an embodiment of a computer screen image 800 for entering data pertaining to a category for an advertising campaign. The computer screen image 800 may be presented to the user when the user selects button 350 in FIG. 3. Selection of button 350 in FIG. 3 may cause the button to expand to illustrate multiple business categories. The user may select from among multiple options that describe businesses. In this example, the user may have selected automobile sales as the business as indicated by the finger icon hovering above the “Automotive” button. Selecting this option may present another computer screen image 850 shown in FIG. 8b. Computer screen image 850 may illustrate multiple product and service options related to the “Automotive” business category. The user may select one or more of the options to further refine the advertising campaign profile. In this example, the user may have selected “new car sales” and “used car sales” as the products and services to be advertised. Upon making a selection or entering data for products and services within a business category, the logic flow 200 may return to the primary computer screen image 300 for the “Create Your Profile” page within MAS website 110 to allow the user to make another selection. The embodiments are not limited to this example.

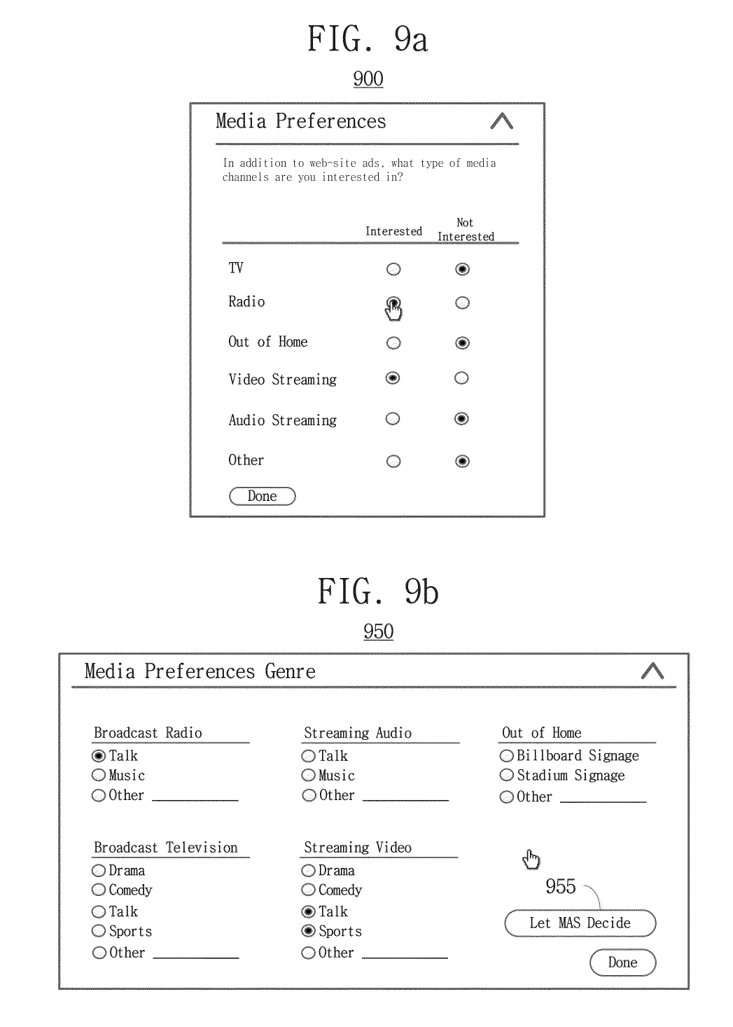

FIG. 9a illustrates one example of an embodiment of a computer screen image 900 for entering data pertaining to media preferences for an advertising campaign. The computer screen image 900 may be presented to the user when the user selects button 360 in FIG. 3. Selection of button 360 in FIG. 3 may cause the button to expand to illustrate multiple media preferences including online audio streaming, online video streaming, broadcast television, broadcast radio, out of home (e.g., billboard signage) or other. In this example, the user may have selected to include broadcast radio and streaming video advertising in the advertising campaign as indicated by the finger icon hovering above the “Radio” button and the “Video Streaming” button being selected. The buttons for other media preferences may have been checked “not interested”. Upon selecting the “Done” button after making a selection or entering data for media preferences a computer screen image 950 shown in FIG. 9b may appear. Computer screen image 950 may illustrate multiple media preference genres available to the user. This may include, but is not limited to, talk and music for broadcast radio and streaming audio. This may also include, but is not limited to, drama, comedy, talk, sports, and other for broadcast television and video streaming. This may also include, but is not limited to, billboard signage, stadium signage for out of home advertisements. The logic flow 200 may return to the primary computer screen image 300 for the “Create Your Profile” page within MAS website 110 to allow the user to make another selection once media preference genres have been selected. The embodiments are not limited to this example.

In another embodiment, the user may decide to let the MAS ad campaign profile engine 130 select the media preference genres based on the information it has gathered from the user. This may be accomplished by selecting the “Let MAS Decide” button 955. The MAS ad campaign profile engine 130 may know the demographic breakdown and cost structure for local media properties and may recommend the most effective approach based on the user input pertaining to budget, location, duration, audience, business category, and products and/or services to be advertised.

Once the user has made selections for each of the advertising criteria buttons, he may click the “Next” button 370 in FIG. 3. Clicking the “Next” button 370 may cause the logic flow 200 to advance to the next stage of the process.

Referring back to the illustrated embodiment shown in FIG. 2, the logic flow 200 may obtain additional user information at block 210. For example, the user may be prompted to input personal and business data to set up an account with the MAS website 110. The data may include name, contact information, payment information, type of business, type of products/services offered and the like. The website management component 125 in conjunction with application database 165 and session database 175 may cooperate to receive the user information and set up a user account for the user. The embodiments are not limited to these examples.

Referring again to the illustrated embodiment shown in FIG. 2, the logic flow 200 may create multiple advertising campaigns based on the advertising profile at block 215. For example, the ad campaign profile engine 130 may process the information gathered pertaining to the advertising campaign criteria to put together multiple campaign options. The multiple advertising campaigns may be the result of processing the responses entered by the user to the various criteria. For example, the three main advertising campaign criteria may be budget, duration, and location. These criteria may cover the overall framework of an advertising campaign. The other criteria, audience, business category (including goods and services to be advertised), and media preferences may assist in creating a localized advertisement campaign based on this data.

The audience criteria, for instance, may express the demographic of consumer that the advertising campaign is to be directed. This could be gender related, age related, income related, or a combination thereof. The media preferences criteria may be considered based on the budget, duration, and location criteria. For instance, if the specified location includes radio stations in higher cost areas such as Philadelphia, there must be sufficient budget to accommodate the media preference. If there is sufficient budget, the cost of a radio spot may vary according to the time of day which may also be considered in constructing an ad campaign package. For instance, there may be enough budget for one radio spot during drive time or two radio spots during a time of day that may not have as many listeners. The business category and goods and services to be advertised may also help determine which media preferences may be most suitable to utilize. The embodiments are not limited to these examples.

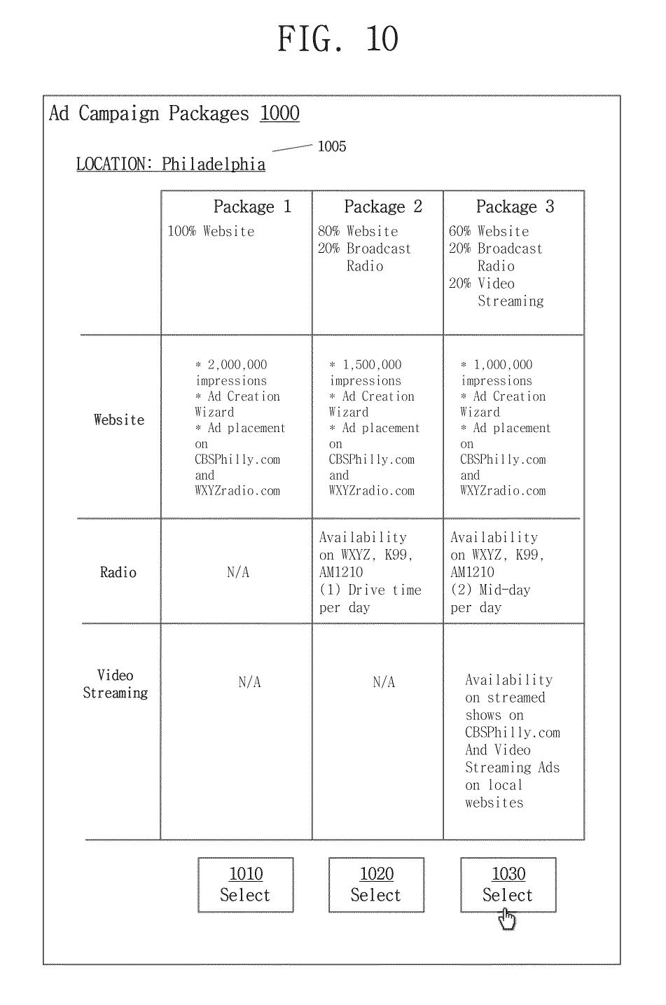

FIG. 10 illustrates one example of an embodiment of a computer screen image 1000 for illustrating multiple advertising campaign packages. Selection of button 370 in FIG. 3 may cause the page associated with computer screen image 1000 to appear. In this example, the user may be presented with three (3) packages labeled package 1, package 2, and package 3. As per the user entered criteria, the location 1005 for each package is specified to be the Philadelphia market.

Package 1 is a 100% website advertising campaign. In this example, package 1 includes provisions for up to 2,000,000 ad impressions over the duration of the advertising campaign on two local websites—CBSPhilly.com and WXYZradio.com. Each of the websites may be a locally oriented website serving the Philadelphia market. Package 1 may also include access to the ad creation wizard 145 within the MAS website 110 to assist the user in creating advertising content. This information may be presented in a row labeled “Website”. A select button 1010 may be clicked by the user to indicate selection of package 1. The embodiments are not limited to these examples.

Package 2 is an 80% online and 20% broadcast radio advertising campaign. In this example, package 2 includes provisions for up to 1,500,000 ad impressions over the duration of the advertising campaign on two local websites—CBSPhilly.com and WXYZradio.com. Package 2 may further include provisions for broadcast radio advertising on local Philadelphia radio stations. In this example, stations WXYZ, K99, and AM1210 may be presented as available. In addition, package 2 may recommend that one radio spot during the “drive time” hours of the day may be best based on the budget and demographic data input by the user. The radio spot recommendation may also be based on the inventory availability of the radio spots for specific radio stations after the ad campaign profile engine 130 queries the inventory database 180. Package 2 may also include access to the ad creation wizard 145 within the MAS website 110 to assist the user in creating website advertising content and audio copy. A select button 1020 may be clicked by the user to indicate selection of package 2. The embodiments are not limited to these examples.

Package 3 is a 60% website, 20% broadcast radio and 20% online video streaming advertising campaign. In this example, package 3 includes provisions for up to 1,000,000 ad impressions over the duration of the advertising campaign on two local websites—CBSPhilly.com and WXYZradio.com. Package 3 may further include provisions for broadcast radio advertising on local Philadelphia radio stations and video streaming advertisements (e.g., commercials) on local Philadelphia websites. In this example, stations WXYZ, K99 and AM1210 may be presented as available for broadcast radio and website CBSPhilly.com may be presented as available for video streaming. The video streaming ads may be inserted into video streamed web programs similar to conventional television advertising or the video streaming ads may be present on a static web page. Video streaming ads on a static web page may be programmed to run when a web browser requests access to the web page. In addition, package 3 may recommend that two radio spot during mid-day may be best based on the budget and demographic data input by the user. The radio spot recommendation may also be based on the inventory availability of the radio spots for specific radio stations after the ad campaign profile engine 130 queries the inventory database 180. Package 3 may also include access to the ad creation wizard 145 within the MAS website 110 to assist the user in creating advertising content. A select button 1030 may be clicked by the user to indicate selection of package 3. The embodiments are not limited to these examples.

Referring again to the illustrated embodiment shown in FIG. 2, the logic flow 200 may receive a selection of an advertising campaign at block 220. For example, the select buttons 1010, 1020, 1030 in FIG. 10 may be clicked by the user to indicate the particular package the user is most interested in pursuing.

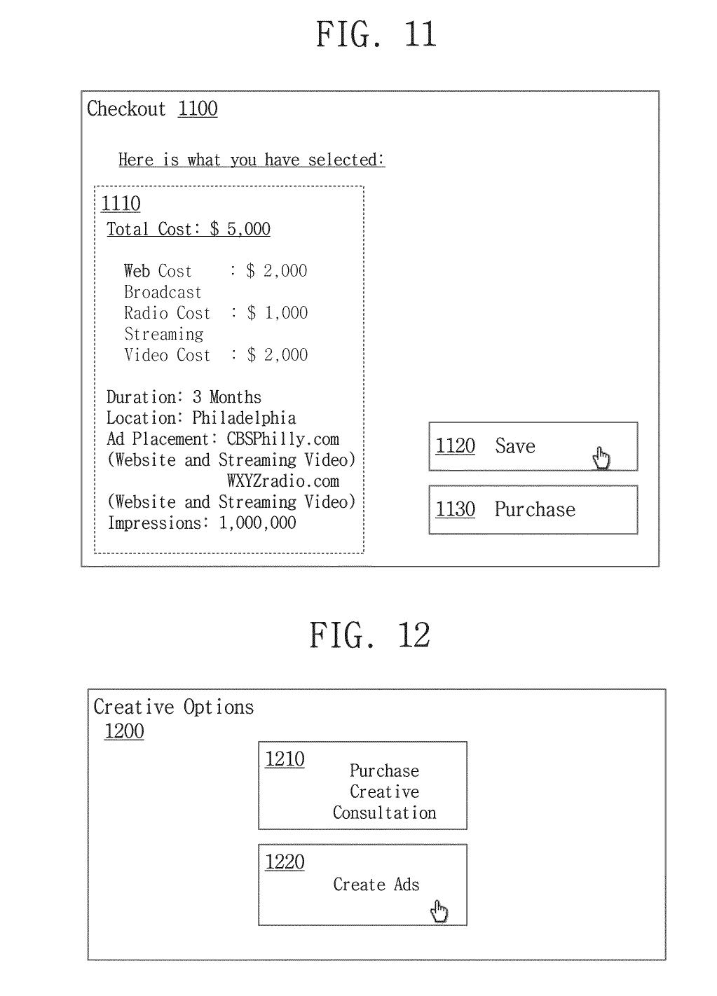

FIG. 11 illustrates one example of an embodiment of a computer screen image 1100 for illustrating a selected advertising campaign option. In this example, a computer image screen 1100 labeled “Checkout” may be presented to summarize the details of the user selected advertising campaign. In this example, the user may have selected package 3 from FIG. 10. A data box 1110 may include the total cost for the advertising campaign (e.g., $5,000) and may further break down the cost according to media preference type which, in this case, is allocated among website, broadcast radio, and video streaming media preferences. The data box 1110 may also include the duration of the advertising campaign at three (3) months, the location of the advertising campaign of Philadelphia, the websites that will carry the website and video streaming advertisements (e.g., CBSPhilly.com and WXYZradio.com), the broadcast radio station that will air the broadcast radio advertisements and the number of impressions the ads may make on the websites (e.g., 1,000,000). There may be two (2) additional buttons that allow the user to “Save” 1120 the package data for later retrieval and “Purchase” 1130 the package.

Selecting the “Save” 1120 button may record the progress of the current session to the session database 175 within database server 160 that is associated with the MAS website 110. Selecting the “Purchase” 1130 button may launch a session on another page within the MAS website 110 that takes payment from the user. This may be accomplished by the payment processing component 158 in conjunction with the external payment processing block 20 (e.g., secure third party website). Upon confirmed payment for the package, the user may be directed to a “Creative Options” section of the MAS website 110. The embodiments are not limited to these examples.

Referring once again to the illustrated embodiment shown in FIG. 2, the logic flow 200 may create advertising content at block 225. For example, the user may create the website advertisements, the audio copy, and the video copy to be used with the selected package for the advertising campaign. The user may create the advertising content with the aid of the ad builder engine 140 and the ad creation wizard 145.

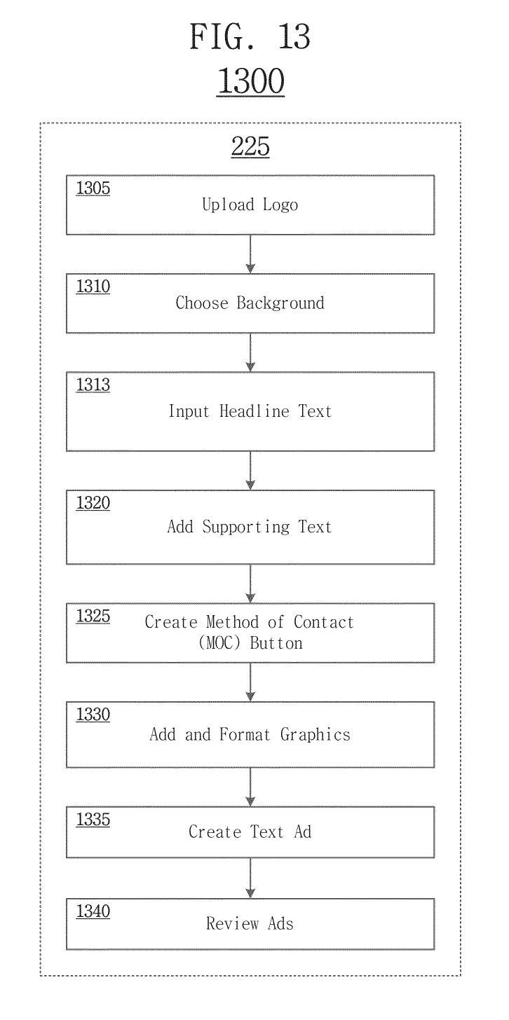

FIG. 12 illustrates an embodiment of a computer screen image 1200 for selecting creative options for a selected advertising campaign. In this example, the user may be presented with options to “Purchase Creative Consultation” 1210 or “Create Ads” 1220. If the user opts to purchase a creative consultation, he will be connected with an ad professional for a fee. The ad professional may then collaborate with the user to help design and create the online advertising content for the advertising campaign using the ad builder engine 140 and the ad creation wizard 145. The user may opt to design and create the online advertising content for the advertising campaign himself using the ad builder engine 140 and the ad creation wizard 145. The processes to create online content are further described with reference to FIG. 13 below. The embodiments are not limited to these examples.

In the illustrated embodiment shown in FIG. 2, the logic flow 200 may upload created advertising content for a selected campaign at block 230. For example, the user may have created multiple website advertisements of different sizes along with audio and video copy using the ad builder engine 140 and the ad creation wizard 145. The completed the website advertisements and audio and video copy may be uploaded to a portion of the content database 170 within database server 160 and associated with a selected campaign and flagged as complete. Prior to upload, the owner of the MAS website 110 may review the advertising content to ensure compliance with any standards that may be in place. The embodiments are not limited to these examples.

In the illustrated embodiment shown in FIG. 2, the logic flow 200 may execute the advertising campaign at block 235. For example, the selected advertising campaign may now be ready to be executed with the aid of the ad campaign execution engine 150. The ad campaign execution engine 150 may comprise a software application operative on the processor component 105. The ad campaign execution engine 150 may be generally arranged to deliver the website advertisements associated with the selected advertising campaign to the websites specified according to the location criteria and also according to the schedule set out by the duration criteria. Similarly, the ad campaign execution engine 150 may be further arranged to deliver the audio and video advertisements associated with the selected advertising campaign to the broadcast radio stations and video streaming websites specified according to the location criteria and according to the schedule set out by the duration criteria. The embodiments are not limited to these examples.

In the illustrated embodiment shown in FIG. 2, the logic flow 200 may obtain advertising campaign feedback for an executed ad campaign at block 240. For example, the user may log-in to the MAS website 110 and access the feedback module 154 to answer a series of questions and provide a scaled score of the advertising campaign. For instance, the user may be asked to rank the overall effectiveness of the advertising campaign. The user may also be asked to rank individual aspects of the advertising campaign such as the online component, the broadcast radio component, the video streaming component, etc. The data gathered by the feedback module may then be placed in the application database 165 where it may be accessed by the history module for future ad campaigns. [As discussed above, CBS should also be able to get analytics on the success of a campaign and provide this as a value-add service to customers who want to know how effective their ad campaigns were and how to further improve those ad campaigns going forward. Please incorporate those ideas here as well]

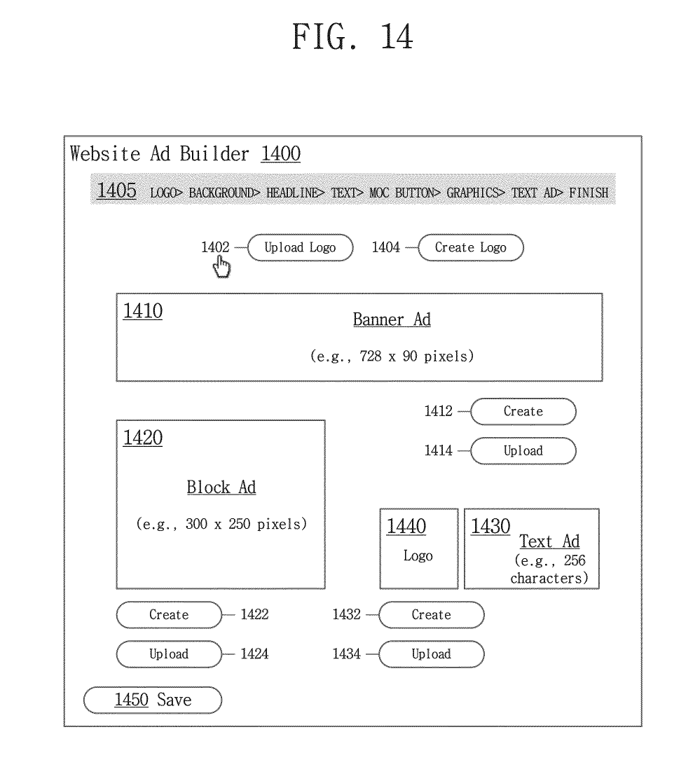

FIG. 13 illustrates an embodiment of a logic flow 1300. The logic flow 1300 may be representative of one or more embodiments for some or all of the operations executed by block 225 of the logic flow in FIG. 2 to create website advertising content using the ad builder engine 140 and the ad creation wizard 145. The steps of FIG. 13 may be described with reference to an embodiment of a computer screen image 1400 for creating website content for a selected advertising campaign shown in FIG. 14.

In the illustrated embodiment shown in FIG. 13, the logic flow 1300 may upload a logo at block 1305. For example, a user may begin creating website advertising content by uploading a logo associated with the user's business. To assist in this step and those that follow, the user may be presented with a computer screen image 1400 for an ad builder within MAS website 110. The computer screen image 1400 for the “Ad Builder” page within MAS website 110 may present an action banner 1405 containing functions that may performed by the ad builder 140. The ad builder page may also present multiple advertising ad blocks of different sizes. The ad builder page may be under control of the ad creation wizard 145 of ad builder engine 140. For instance, a blank banner ad template box 1410 may be presented. The banner ad template box 1410 may be specifically sized to reflect standard web advertising blocks. In this example, the banner ad template box 1410 may be sized at 728×90 pixels. The banner ad template box 1410 may accommodate both text and graphics as will be further described. A second blank block ad template box 1420 may also be presented. The block ad template box 1420 may be specifically sized to reflect standard web advertising blocks. In this example, the block ad template box 1420 may be sized at 300×250 pixels. The block ad template box 1420 may accommodate both text and graphics as will be further described. In addition, a second blank block ad template box 1430 may also be presented. The text ad template box 1430 may be specifically sized to reflect standard web advertising blocks. In this example, the text ad template box 1430 may be limited to 256 characters. The text ad template box 1430 may also be associated with a logo graphic 1440. Each of the banner and block ads may be comprised of one or more of a logo, other graphical images or pictures, headline text, and supporting text. The embodiments are not limited to these examples.

At block 1305, the user may upload a logo by clicking the “Upload Logo” box 1402 in FIG. 14. Clicking the “Upload Logo” box 1402 may cause the ad builder engine 140 to prompt the user to search in memory associated with his computer for an image to be used as the logo. Once the user locates the desired logo image and clicks on the file, it may be uploaded into the ad builder engine 140 and placed into each of the ad template boxes 1410, 1420, 1440 shown in FIG. 14. The user may then adjust the size and/or location of the logo within each of the ad template boxes 1410, 1420 and 1440.

If the user opts to create a logo using selection box 1404, the ad builder may present a screen that allows the user to organize graphics and/or text into a relatively small icon. Once created, the logo may be uploaded into the ad builder engine 140 and placed into each of the ad template boxes 1410, 1420, 1440 shown in FIG. 14. The user may then adjust the size and/or location of the logo within each of the ad template boxes 1410, 1420 and 1440. The embodiments are not limited to this example.

In the illustrated embodiment shown in FIG. 13, the logic flow 1300 may choose a background for the website advertisements at block 1310. For example, clicking the “Create” box 1412 or “Upload” box 1414 associated with banner ad template box 1410 may cause the ad builder engine 140 to prompt the user to select a background color for the online banner advertising. The user may be assisted in this task by the ad creation wizard 145 presenting a color scale that the user may select from. The user may make a selection from the color scale and the ad builder engine 140 may fill in the ad template box 1410. The user may then adjust the size and/or location of the logo within the banner ad template box 1410. The same background creating process may be repeated for the block ad template box 1420 clicking the “Create” box 1422 or “Upload” box 1424 associated with block ad template box 1420. Upon completion of the background color selection, the user may be directed to a page for inputting headline text for the online advertising. The embodiments are not limited to these examples.

In the illustrated embodiment shown in FIG. 13, the logic flow 1300 may receive input for headline text at block 1315. For example, clicking the “Create” box 1412 or “Upload” box 1414 associated with banner ad template box 1410 may cause the ad builder engine 140 may prompt the user to input headline text for the online banner advertising. The headline text may be the more prominent of words contained in the online advertising. The user may be assisted in this task by the ad creation wizard 145 presenting a text box into which the user may type. In addition, the user may be allowed to change the color, font type and font size of the headline text. The ad builder engine 140 may then fill in the ad template box 1410 with the user supplied headline text. The user may then adjust the size and/or location of the headline text within the banner ad template box 1410. The same headline text creating process may be repeated for the block ad template box 1420 clicking the “Create” box 1422 or “Upload” box 1424 associated with block ad template box 1420. Upon completion of the headline text creation, the user may be directed to a page for inputting supporting text for the online advertising. The embodiments are not limited to these examples.

In the illustrated embodiment shown in FIG. 13, the logic flow 1300 may receive input for supporting text at block 1320. For example, clicking the “Create” box 1412 or “Upload” box 1414 associated with banner ad template box 1410 may cause the ad builder engine 140 to prompt the user to input supporting text for the online banner advertising. The supporting text may be the less prominent of words contained in the online advertising. The user may be assisted in this task by the ad creation wizard 145 presenting a text box into which the user may type. In addition, the user may be allowed to change the color, font type and font size of the supporting text. The ad builder engine 140 may then fill in the ad template box 1410 with the user supplied supporting text. The user may then adjust the size and/or location of the supporting text within the banner ad template box 1410. The same supporting text creating process may be repeated for the block ad template box 1420 clicking the “Create” box 1422 or “Upload” box 1424 associated with block ad template box 1420. Upon completion of the supporting text creation, the user may be directed to a page for creating a method of contact (MOC) button for the website advertising. The embodiments are not limited to these examples.

In the illustrated embodiment shown in FIG. 13, the logic flow 1300 may create a method of contact (MOC) button at block 1325. A method of contact (MOC) button may be a relatively small icon associated with a hyperlink to the user's website. The goal of the website advertising may be to cause someone browsing a website containing the website advertising to click the MOC button and be re-directed to the user's website for commercial purposes. For example, clicking the “Create” box 1412 or “Upload” box 1414 associated with banner ad template box 1410 may cause the ad builder engine 140 may prompt the user to input text to be placed within the MOC button as well as a universal resource locator (URL) web address to be associated with the MOC button. One example of MOC button text may be “Learn More”. The MOC button may be included within the banner advertising such that when it is clicked, it will re-direct the web browser to the URL associated with the MOC button. The same MOC button creating process may be repeated for the block ad template box 1420 clicking the “Create” box 1422 or “Upload” box 1424 associated with block ad template box 1420. Upon completion of the MOC button creation, the user may be directed to a page for adding graphics to the online advertising. The embodiments are not limited to these examples.

In the illustrated embodiment shown in FIG. 13, the logic flow 1300 may add and format graphics at block 1330. For example, clicking the “Create” box 1412 or “Upload” box 1414 associated with banner ad template box 1410 may cause the ad builder engine 140 may prompt the user to select photos or graphics to be added to the website banner advertising. The photos or graphics may be stored on the user's computer and may be uploaded into the ad builder 140. The ad builder engine 140 may then fill in the ad template box 1410 with the user uploaded photos or graphics. The user may then adjust the size and/or location of the photos or graphics within the banner ad template box 1410. The same add and format graphics process may be repeated for the block ad template box 1420 clicking the “Create” box 1422 or “Upload” box 1424 associated with block ad template box 1420. Upon completion of the add and format graphics process, the user may be directed to a page for creating a text ad for the online advertising. The embodiments are not limited to these examples.

In the illustrated embodiment shown in FIG. 13, the logic flow 1300 may create a text ad at block 1335. For example, clicking the “Create” box 1432 or “Upload” box 1434 associated with banner ad template box 1410 may cause the ad builder engine 140 may prompt the user to input text for the website text only advertising. The text may be limited to a certain number of characters. The user may be assisted in this task by the ad creation wizard 145 presenting a text box into which the user may type. In addition, the user may be allowed to change the color, font type and font size of the supporting text. The ad builder engine 140 may then fill in the text ad template box 1430 with the user supplied text. The text ad may not be as robust as the banner ad or the block ad with respect to graphics and backgrounds. The text ad may, however, be accompanied by a small icon such as, for instance, the user's logo. Upon completion of the text ad creation, the user may be directed to a page for reviewing the website advertisements just created. The embodiments are not limited to these examples.

In the illustrated embodiment shown in FIG. 13, the logic flow 1300 may review created ads at block 1340. For example, the ad builder engine 140 may present to the user images of each of the ad boxes 1410, 1420, 1430, 1440 just created. The user may then review the advertisements to ensure everything appears as desired. The user may then edit the website advertising prior to performing a final save using “Save” button 1450. The embodiments are not limited to these examples.

While not shown, a user may create and upload audio copy and video copy similar to the process described in the logic flow diagram 1300 in FIG. 13. For example, a user may upload an audio file by clicking an “Upload Audio” box from a webpage within the MAS website 110 that may cause the ad builder engine 140 to prompt the user to search in memory associated with the user's network enabled computer 15 for an audio file to be imported. The user may create an audio file by clicking a “Create Audio” box from a webpage within the MAS website 110 that may cause the ad builder engine 140 to prompt the user to record an audio message into a microphone associated with the user's network enabled computer 15. The audio message may then be uploaded as an audio file to the MAS web-site 110.

The user may upload a video file by clicking an “Upload Video” box from a webpage within the MAS website 110 that may cause the ad builder engine 140 to prompt the user to search in memory associated with the user's network enabled computer 15 for a video file to be imported. The user may create a video file by clicking a “Create Video” box from a webpage within the MAS website 110 that may cause the ad builder engine 140 to prompt the user to record a video into a video camera associated with the user's network enabled computer 15. The video may then be uploaded as a video file to the MAS web-site 110. The imported and/or created audio and video files may be stored in content database 170 and associated with a user's advertising campaign.

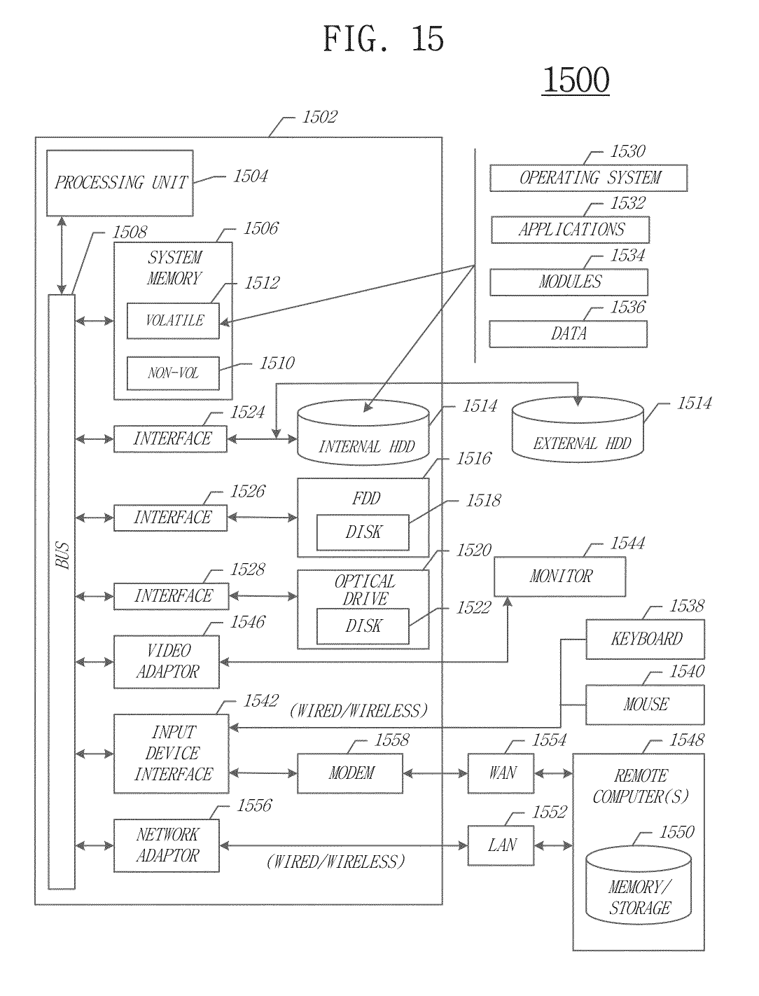

FIG. 15 illustrates an embodiment of an exemplary computing architecture 1500 suitable for implementing various embodiments as previously described. In one embodiment, the computing architecture 1500 may comprise or be implemented as part of an electronic device. The embodiments are not limited in this context.

As used in this application, the terms “system” and “component” are intended to refer to a computer-related entity, either hardware, a combination of hardware and software, software, or software in execution, examples of which are provided by the exemplary computing architecture 1500. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1500 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1500.

As shown in FIG. 15, the computing architecture 1500 comprises a processing unit 1504, a system memory 1506 and a system bus 1508. The processing unit 1504 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 1504.

The system bus 1508 provides an interface for system components including, but not limited to, the system memory 1506 to the processing unit 1504. The system bus 1508 can be any of several types of bus structure that may further interconnect to a memory bus (with or without a memory controller), a peripheral bus, and a local bus using any of a variety of commercially available bus architectures. Interface adapters may connect to the system bus 1508 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 1500 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1506 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 15, the system memory 1506 can include non-volatile memory 1510 and/or volatile memory 1512. A basic input/output system (BIOS) can be stored in the non-volatile memory 1510.

The computer 1502 may include various types of computer-readable storage media in the form of one or more lower speed memory units, including an internal (or external) hard disk drive (HDD) 1514, a magnetic floppy disk drive (FDD) 1516 to read from or write to a removable magnetic disk 1518, and an optical disk drive 1520 to read from or write to a removable optical disk 1522 (e.g., a CD-ROM or DVD). The HDD 1514, FDD 1516 and optical disk drive 1520 can be connected to the system bus 1508 by a HDD interface 1524, an FDD interface 1526 and an optical drive interface 1528, respectively. The HDD interface 1524 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1510, 1512, including an operating system 1530, one or more application programs 1532, other program modules 1534, and program data 1536. In one embodiment, the one or more application programs 1532, other program modules 1534, and program data 1536 can include, for example, the various applications and/or components of the system 100.

A user can enter commands and information into the computer 1502 through one or more wire/wireless input devices, for example, a keyboard 1538 and a pointing device, such as a mouse 1540. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 1504 through an input device interface 1542 that is coupled to the system bus 1508, but can be connected by other interfaces such as a parallel port, IEEE 1394 serial port, a game port, a USB port, an IR interface, and so forth.

A monitor 1544 or other type of display device is also connected to the system bus 1508 via an interface, such as a video adaptor 1546. The monitor 1544 may be internal or external to the computer 1502. In addition to the monitor 1544, a computer typically includes other peripheral output devices, such as speakers, printers, and so forth.

The computer 1502 may operate in a networked environment using logical connections via wire and/or wireless communications to one or more remote computers, such as a remote computer 1548. The remote computer 1548 can be a workstation, a server computer, a router, a personal computer, portable computer, microprocessor-based entertainment appliance, a peer device or other common network node, and typically includes many or all of the elements described relative to the computer 1502, although, for purposes of brevity, only a memory/storage device 1550 is illustrated. The logical connections depicted include wire/wireless connectivity to a local area network (LAN) 1552 and/or larger networks, for example, a wide area network (WAN) 1554. Such LAN and WAN networking environments are commonplace in offices and companies, and facilitate enterprise-wide computer networks, such as intranets, all of which may connect to a global communications network, for example, the Internet.

When used in a LAN networking environment, the computer 1502 is connected to the LAN 1552 through a wire and/or wireless communication network interface or adaptor 1556. The adaptor 1556 can facilitate wire and/or wireless communications to the LAN 1552, which may also include a wireless access point disposed thereon for communicating with the wireless functionality of the adaptor 1556.

When used in a WAN networking environment, the computer 1502 can include a modem 1558, or is connected to a communications server on the WAN 1554, or has other means for establishing communications over the WAN 1554, such as by way of the Internet. The modem 1558, which can be internal or external and a wire and/or wireless device, connects to the system bus 1508 via the input device interface 1542. In a networked environment, program modules depicted relative to the computer 1502, or portions thereof, can be stored in the remote memory/storage device 1550. It will be appreciated that the network connections shown are exemplary and other means of establishing a communications link between the computers can be used.

The computer 1502 is operable to communicate with wire and wireless devices or entities using the IEEE 802 family of standards, such as wireless devices operatively disposed in wireless communication (e.g., IEEE 802.15 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.15x (a, b, g, n, etc.) to provide secure, reliable, fast wireless connectivity. A Wi-Fi network can be used to connect computers to each other, to the Internet, and to wire networks (which use IEEE 802.3-related media and functions).

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A system, comprising:
a processor component;
a website management component operative on the processor component to manage sessions associated with an account of a user while interacting with a website operative on the processor component;
an ad campaign profile engine operative on the processor component to create one or more advertising campaigns based on multiple advertising profile criteria, the one or more advertising campaigns including media preference options for online and offline media properties, the campaign profile wizard further to accept a selection of one of the one or more advertising campaigns; and
an ad builder engine operative on the processor component to create advertising content for the selected advertising campaign.

2. The system of claim 1, the ad campaign profile engine comprising a campaign profile wizard operative to:
present the multiple advertising profile criteria;
prompt for input for each of the multiple advertising profile criteria; and
accept input for each of the multiple advertising profile criteria.

3. The system of claim 2, the multiple criteria pertaining to the advertising campaign including a budget for the advertising campaign, a duration for the advertising campaign, a location for the advertising campaign, a target audience for the advertising campaign, a business category, a product or service associated with the business category to be advertised, multiple media preferences, multiple media preference genres for the advertising campaign and to accept input pertaining to the multiple criteria, and a historical assessment of similar advertising campaigns.

4. The system of claim 3, comprising:
a feedback module to obtain feedback data pertaining to the effectiveness of an advertising campaign;
a history module to maintain historical data for multiple advertising campaigns; and
an analytics engine to determine trend data based on data obtained by the feedback module and the history module.

5. The system of claim 4, the media preferences comprising external website advertising, online audio streaming advertising, online video streaming advertising, broadcast radio advertising, broadcast television advertising, and outdoor signage advertising.

6. The system of claim 5, comprising an offline media engine communicable with an inventory database, the inventory database including data representative of ad spots that are available for purchase on multiple offline media properties, the inventory data further comprising data specifying the geographic area covered by the multiple offline media properties, and a date, time, and cost of the ad spots that are available on each of the multiple offline media properties.

7. The system of claim 6, in which the data representative of ad spots that are available for purchase on multiple offline media properties is uploaded automatically to the inventory database on a predefined periodic basis.

8. The system of claim 4, the campaign profile wizard to automatically create the multiple advertising campaigns based on the accepted input for each of the multiple advertising profile criteria and the trend data determined by the analytics engine.

9. The system of claim 8, the ad builder engine comprising an ad creation wizard operative to:
present multiple advertising template boxes of different pixel sizes;
prompt for input for each of the multiple advertising template boxes;
accept input for each of the multiple advertising template boxes; and
organize the input within each of the multiple advertising template boxes; and
store the organized input as advertisement content associated with the selected advertising campaign.

10. The system of claim 9, the input for each of the multiple advertising template boxes comprising a background color, text, graphics, photos, and a method of contact (MOC) button.

11. The system of claim 10, the ad creation wizard to:
adjust the font size and font type of text input;
adjust the location within the multiple advertising template boxes of the text input;
adjust the size of a graphic or photo input; and
adjust the location within the multiple advertising template boxes of the graphic or photo input.

12. The system of claim 8, the ad builder engine comprising an ad creation wizard operative to:
prompt for input pertaining to uploading an audio file;
accept input pertaining to uploading the audio file;
prompt for input pertaining to creating the audio file;
accept input pertaining to creating the audio file;
associate the audio file with the selected advertising campaign; and
store the audio file as advertising content associated with the selected advertising campaign.

13. The system of claim 8, the ad builder engine comprising an ad creation wizard operative to:
prompt for input pertaining to uploading an video file;
accept input pertaining to uploading the video file;
prompt for input pertaining to creating the video file;
accept input pertaining to creating the video file;
associate the video file with the selected advertising campaign; and
store the video file as advertising content associated with the selected advertising campaign.

14. The system of claim 1, further comprising an ad execution engine operative on the processor component to cause delivery of the advertising content to the online and offline media properties associated with the selected advertising campaign.

15. The system of claim 1, further comprising a feedback module operative on the processor component to receive feedback indicative of the effectiveness of the selected advertising campaign following its execution.

16. A computer-implemented method, comprising:
creating an advertising profile based on advertisement profile criteria including a budget for the advertising campaign, a duration for the advertising campaign, a location for the advertising campaign, a target audience for the advertising campaign, a business category, a product or service associated with the business category to be advertised, and online and offline media properties on which advertisements appear; and
automatically creating one or more advertising campaigns based on the advertising profile and trend data obtained from an analysis of other advertising campaigns, each of the multiple advertising campaigns including media preference options for online and offline media properties.

17. The computer-implemented method of claim 16, comprising:
receiving a selection of one of the advertising campaigns; and
creating advertising content for the selected advertising campaign.

18. The computer-implemented method of claim 17, the media preferences comprising website advertising, online audio streaming advertising, online video streaming advertising, broadcast radio advertising, broadcast television advertising, and outdoor signage advertising.

19. The computer-implemented method of claim 18, comprising:
receiving inventory data representative of ad spots that are available for purchase on multiple offline media properties, the inventory data further comprising data specifying the geographic area covered by the multiple offline media properties, and a date, time, and cost of the ad spots that are available on each of the multiple offline media properties; and
storing the inventory data in an inventory database; and
using the inventory data to make recommendations in one or more of the multiple advertising campaigns.

20. The computer-implemented method of claim 19, the creating the advertising profile comprising:
presenting the advertising profile criteria;
prompting for input for each of the advertising profile criteria; and
accepting input for each of the advertising profile criteria.

21. The computer-implemented method of claim 20, the creating the advertising content comprising:
presenting multiple website advertising template boxes of different sizes;
prompting for input for each of the multiple website advertising template boxes;
accepting input for each of the multiple website advertising template boxes; and
organizing the input within each of the multiple website advertising template boxes.

22. The computer-implemented method of claim 21, the input for each of the multiple website advertising template boxes comprising a background color, text, graphics, photos, and a method of contact (MOC) button.

23. The computer-implemented method of claim 22, the organizing the input within each of the multiple website advertising template boxes comprising:
adjusting the font size and font type of text input;
adjusting the location within the multiple website advertising template boxes of the text input;
adjusting the size of a graphic or photo input; and
adjusting the location within the multiple website advertising template boxes of the graphic or photo input.

24. The computer-implemented method of claim 16, further comprising:
prompting for input pertaining to uploading an audio file;
accepting input pertaining to uploading the audio file;
prompting for input pertaining to creating the audio file;
accepting input pertaining to creating the audio file;
associating the audio file with the selected advertising campaign; and
storing the audio file as advertising content associated with the selected advertising campaign.

25. The computer-implemented method of claim 16, further comprising:
prompting for input pertaining to uploading an video file;
accepting input pertaining to uploading the video file;
prompting for input pertaining to creating the video file;
accepting input pertaining to creating the video file;
associating the video file with the selected advertising campaign; and
storing the video file as advertising content associated with the selected advertising campaign.

26. The computer-implemented method of claim 16, comprising executing the selected advertising campaign by causing the advertising content to appear on the one or more media preferences.

27. The method of claim 16, further comprising receiving feedback indicative of the effectiveness of the selected advertising campaign following its execution.

28. At least one computer-readable storage medium comprising instructions that, when executed, cause a system to:
create an advertising profile based on advertisement profile criteria including a budget for the advertising campaign, a duration for the advertising campaign, a location for the advertising campaign, a target audience for the advertising campaign, a business category, a product or service associated with the business category to be advertised, and online and offline media properties on which advertisements appear; and
automatically create multiple advertising campaigns based on the advertising profile and trend data obtained from an analysis of other advertising campaigns, each of the multiple advertising campaigns including media preference options for online and offline media properties.

29. The computer-readable storage medium of claim 28, comprising instructions that when executed cause the system to:
receive a selection of one of the advertising campaigns;
create advertising content for the selected advertising campaign; and
execute the selected advertising campaign by causing the advertising content to appear on one or more of the online and offline media.

30. The computer-readable storage medium of claim 28, the media preferences comprising website advertising, online audio streaming advertising, online video streaming advertising, broadcast radio advertising, broadcast television advertising, and outdoor signage advertising.

31. The computer-readable storage medium of claim 30, comprising instructions that when executed cause the system to:
receive inventory data representative of ad spots that are available for purchase on multiple offline media properties, the inventory data further comprising data specifying the geographic area covered by the multiple offline media properties, and a date, time, and cost of the ad spots that are available on each of the multiple offline media properties; and
store the inventory data in an inventory database; and
use the inventory data to make recommendations in one or more of the multiple advertising campaigns.

32. The computer-readable storage medium of claim 31 comprising instructions that when executed cause the system to:
present the advertising profile criteria;
prompt for input for each of the advertising profile criteria; and
accept input for each of the advertising profile criteria.

33. The computer-readable storage medium of claim 32, comprising instructions that when executed cause the system to:
present multiple website advertising template boxes of different sizes;
prompt for input for each of the multiple website advertising template boxes;
accept input for each of the multiple website advertising template boxes; and
organize the input within each of the multiple website advertising template boxes.

34. The computer-readable storage medium of claim 33, the input for each of the multiple website advertising template boxes comprising a background color, text, graphics, photos, and a method of contact (MOC) button.

35. The computer-readable storage medium of claim 34, comprising instructions that when executed cause the system to:
adjust the font size and font type of text input;
adjust the location within the multiple website advertising template boxes of the text input;
adjust the size of a graphic or photo input; and
adjust the location within the multiple website advertising template boxes of the graphic or photo input.

36. The computer-readable storage medium of claim 32, comprising instructions that when executed cause the system to:
prompt for input pertaining to uploading an audio file;
accept input pertaining to uploading the audio file;
prompt for input pertaining to creating the audio file;
accept input pertaining to creating the audio file;
associate the audio file with the selected advertising campaign; and
store the audio file as advertising content associated with the selected advertising campaign.

37. The computer-readable storage medium of claim 32, comprising instructions that when executed cause the system to:
prompt for input pertaining to uploading an video file;
accept input pertaining to uploading the video file;
prompt for input pertaining to creating the video file;
accept input pertaining to creating the video file;
associate the video file with the selected advertising campaign; and
store the video file as advertising content associated with the selected advertising campaign.

38. The computer-readable storage medium of claim 28, comprising instructions that when executed cause the system to:
receive feedback indicative of the effectiveness of the selected advertising campaign following its execution.
